(19) United States
(12) Patent Application Publication
(10) Pub. No.: US 2006/0096712 A1
(43) Pub. Date: May 11, 2006

(54) Bottom tape replacement system

(76) Inventors: Chris Peter Makar, Vancouver (CA); Peter Clive Sewell, Vancouver (CA)

Correspondence Address: C.A. Rowley, 51 Riverside Parkway, P.O. Box 59, Frankford, ON, KOK 2C0, CA

(21) Appl. No.: 10/981,451

(22) Filed: Nov. 5, 2004

(51) Int. Cl. B32B 37/00; B32B 38/04

(52) U.S. Cl. 156/538; 156/510; 156/556

(57) ABSTRACT

In a machine for applying tape to the bottom of a case or carton the tape head is pivotable mounted for movement between a taping position and an access position where the tape or tape head may easily be changed mounting and a lever accessibly positioned to one side of said frame is connected to the tape head so that movement of said leaver in one direction pivots said tape head an accessible recharging position wherein said tape head is readily accessed.

### FIELD OF INVENTION

The present invention relate to a simplified and more effective system for changing the tape of a bottom tape head for a case erector or the like, more particularly to lever system for moving the tape head.

### BACKGROUND OF THE PRESENT INVENTION

Attention is directed to U.S. Pat. No. 4,553,954 issued Nov. 19, 1985 Sewell et al. which shows one form of machine, in this example, an erector to which the present invention may be applied.

One of the recurring actions that must be preformed in any tape applying operation is to replace the tape (or tape head) during the forming or erection of a case or box and/or tape sealing of the filed box or case. The problem is more pronounced in the taping of the bottom of the box as the tape head is positioned below the path of travel of the box as it is being made and thus the tape head is located in a place where it is not easily accessed. Many unsuccessful attempts have been made to permit easy changing of the tape head or recharging of the tape head have been suggested.

With respect to a top head which is readily available in that it is mounted above the box and after the packing station it has been suggested and/or tried to use magazines from which full tape heads are dispensed to replace the one from which all the tape has been dispensed and or replace the tape per se.

For bottom tape heads the procedure for years has been to reach into and lift the empty tape head and retrieve it from its operative position and then either apply a fresh roll to the retrieved tape head or insert a new recharged tape head back into the machine and then the erecting operation continued to process more boxes.

It is believed that in some machines the mounting system for the tape head has been pivotably mounted in the machine so that the operator could reach in and pivot the head out to a position where it could be accessed to change the tape, however this system is not significantly quicker or easier to use than the system where the operator simply reached in and lifted out the tape head.

### BRIEF DESCRIPTION OF THE PRESENT INVENTION

It is the main object of the present invention to provide a relatively simple, easily used system for quick and easy recharging or replacement of a bottom tape head.

Broadly the present invention relates to a machine for applying tape comprising a tape head, mounting means for mounting said tape head in a frame of said machine in an operative taping position for a case to pass there over and said tape head apply tape a bottom of said case as said case is moved there over, said mounting means being pivotably mounted in said frame for rotation about a rotational axis, a lever, means connecting said lever to said mounting means, said lever being accessibly positioned to one side of said frame so that movement of said leaver in one direction pivots said mounting means and said tape head on said rotational axis from said taping position to an accessible position wherein said tape head is readily accessed.

Preferably, said means connecting said lever comprises a shaft having its longitudinal axis aligned with said rotational axis.

Preferably, said mounting means comprises an arm connected to said shaft and a quick disconnect coupling releasably connecting said tape head to said arm.

Preferably, said rotational axis is adjacent to a front of said machine in the direction of movement of a case through said machine for taping and said accessible position is above and toward the front of said machine.

### BRIEF DESCRIPTION OF THE SEVERAL VIEWS OF THE DRAWINGS

Further features, objects and advantages will be evident from the following detailed description of the preferred embodiments of the present invention taken in conjunction with the accompanying drawings in which;

FIG. 1 is an isometric view with parts omitted showing the frame of the machine and the tape head in operative position to tape the bottom of a case in a tape applying station.

FIG. 2 is an isometric view with parts omitted similar to FIG. 1 but showing the tape head in accessible position to permit easy replacement of the tape or whole tape head.

FIG. 3 is an isometric view of the tape head in accessible (tilted out) position on a specific machine with the guarding in position.

FIG. 4 is a view with parts omitted showing the tilt out system in isolation with a tape head mounted in position.

FIG. 5 is a view similar to FIG. 4 showing an exploded view with a tape head disconnected from its mounting arm.

FIG. 6 is a schematic view with parts omitted taken through the coupling on the line 6-6 of FIG. 4.

### DETAILED DESCRIPTION OF THE INVENTION

Referring to FIG. 1 the taper 10 of the present invention includes a frame 12 that supports a bottom tape applying station 14. The frame 12 is preferably mounted on suitable legs 16 and is constructed to provide room as indicated 18 to the rear of the taping station 14 in the direction of movement of a case through the machine as indicated by the arrow 20. Generally the space 18 will mount an erecting and bottom folding station (see for example U.S. Pat. No. 4,553,954).

The station 14 as illustrated includes a pair of side rails 22 and 24 which generally are used to mount hold down devices and the like and mounted so that the width of spacing between the two rails measured perpendicular to the direction 20 of movement of a case adjustable in known manner via the hand wheel 26 to accommodate different with cases.

A tape head 28 for applying tape to the bottom of a case as it is moved through the station 14 in the direction as indicated by the arrow 20 is mounted generally in a centered position between the rails 22 and 24 and in position to apply tape to the bottom of the case. The tape head 28 is mounted on a suitable mounting means which in the illustrated arrangement is an arm 30 to which the taping head 28 is attached (easily releasably attached if the whole head is to be changed). The arm 30 in turn is mounted for pivotal movement about a pivotal axis 32 substantially perpendicular to the direction of movement 20. In the illustrated arrangement the pivotal axis 32 is aligned with the longitudinal axis of a shaft 34 mounted in suitable bearings 36 (only one shown) adjacent to the front cross member 38 of the frame 12 for rotation relative to the frame 12.

The arm 30 is fixed to the shaft 34 so that rotation of the shaft 34 causes the arm 30 and the tape head 28 carried thereby to rotate about the axis 32.

The shaft 34 extends out through the side of the frame 12 and is attached to a lever 40 that is positioned adjacent to the side of the machine 10 i.e. outside the longitudinal side rail 42 in a position to be easily accessible to an operator.

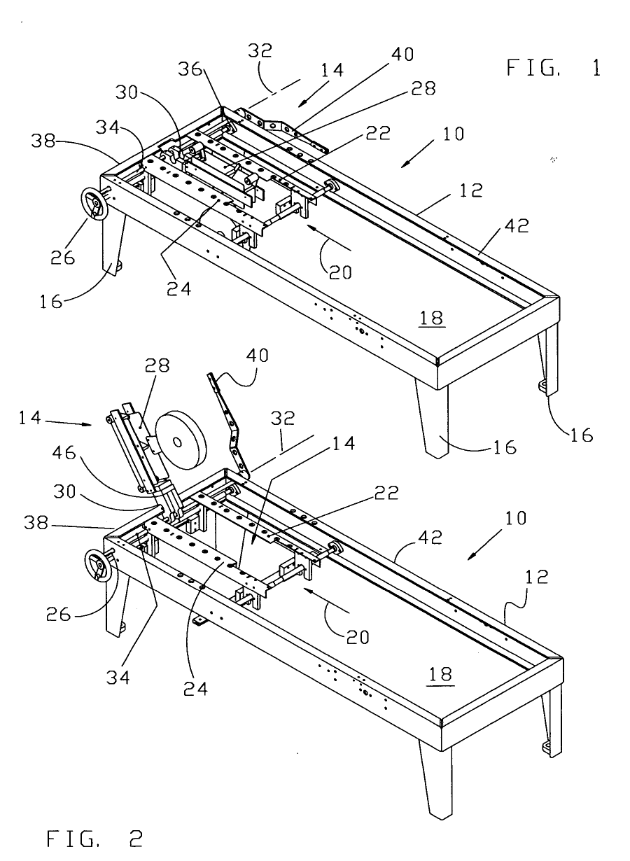

The lever 40 is very important as it makes it easy for an operator to move the tape head 28 between the operative position as shown in FIG. 1 with the tape head 28 between the rails 22 and 24 and underlying the path of travel of a case and an exposed easily accessed position 44 as shown in FIG. 2.

In the accessible position 44 the operate may easily replace the tape in a tape head mounted on the arm 30, or assuming a suitable easily disconnect coupling as schematically indicated at 46 between the arm 30 and the head 28 is provided the used tape head may be disconnect and replaced with a different tape head that earlier had been recharged with tape and is ready to go.

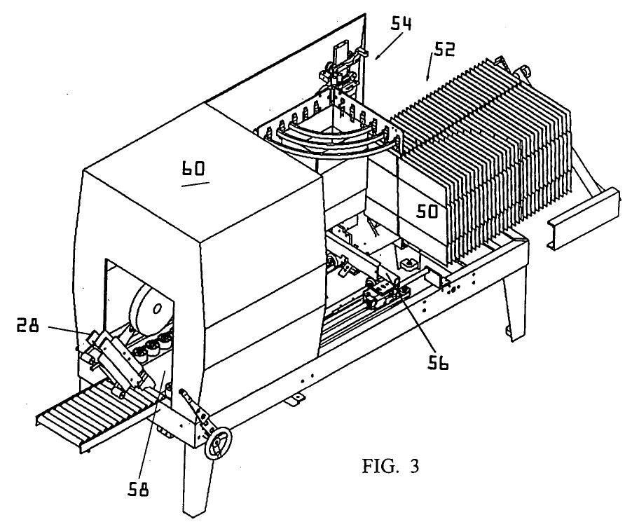

FIG. 3 shows the invention applied to a specific machine and with at least some of the required guarding in position. In this system the individual knocked down case or box blanks 50 are removed from a magazine 52 are squared in squaring station 54 and the lowered and their bottom flaps fold in the bottom flap folding station 56 and then are moved substantially horizontally to and through the bottom taping station 58. It will be noted that guarding 60 obstructs access to the taping station 58 making it more difficult to access the tape head 28 and replace the tape. It is apparent that the present invention wherein the tape head is easily tilted from the machine into accessible position as shown in FIGS. 2 and 3 greatly facilitates the changing of the tape.

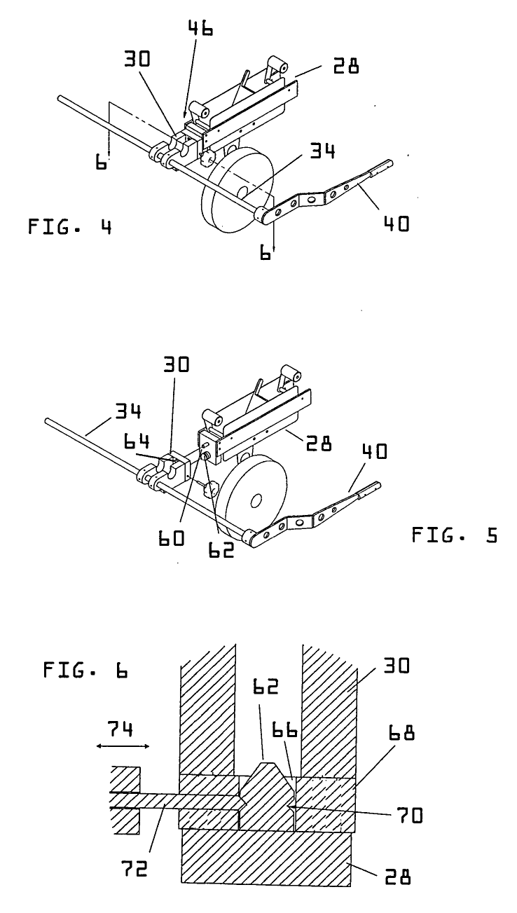

FIGS. 4, 5 and 6 show the quick disconnect coupling 46 schematically and in more detail. In these Figures the position of the handle or lever 40 has been moved to the opposite side of the machine. As shown in FIG. 5 and 6 the coupling 46 is formed by a positioning and guiding pin 60 and a latching pin 62 that project from the tape head 28 which are received in their respective holes 64 (see FIG. 5) and 66 (see FIG. 6) through the plate 68 which forms the end of the arm 30. The latching pin 62 has a notch 70 into which a release pin 72 is biased as schematically represented by the arrow 74. The release pin 72 has a hand grip 76 at it exposed end. It will be apparent that when a tape head 28 is to be changed it is first tipped to the position shown in FIGS. 2 or 3 and the operator then grasps the grip 76 and pulls the pin 72 against the bias 74 to move the pin 72 out of the notch 70 and release the tape head 28 in the machine. The operator then removes the used tape head 28 from the machine and mounts a replacement tape head with its pins 60 and 62 in their respective holes into the holes out 64 and 66 and releases the pin 72 so that the bias force 74 forces the pin 72 into the notch 70 in the pin 66 to lock the new head in position.

It will be evident that the tilt out mechanism using the lever 40 which facilitates manual movement of the tape head could be modified to provide a mechanical or pneumatic assist for turning the shaft 34.

Having described the invention, modifications will be evident to those skilled in the art without departing from the scope of the invention as defined in the appended claims.

We claim:

1. A machine for applying tape comprising a tape head, mounting means for mounting said tape head in a frame of said machine in an operative taping position for a case to pass there over and said tape head apply tape a bottom of said case as said case is moved there over, said mounting means being pivotably mounted in said frame for rotation about a rotational axis, a lever, means connecting said lever to said mounting means, said lever being accessibly positioned to one side of said frame so that movement of said leaver in one direction pivots said mounting means and said tape head on said rotational axis from said taping position to an accessible position wherein said tape head is readily accessed.

2. A machine for applying tape as defined in claim 1 wherein said means connecting said lever comprises a shaft having its longitudinal axis aligned with said rotational axis and to which said mounting means is attached.

3. A machine for applying tape as defined in claim 2 wherein said mounting means comprises an arm connected to said shaft and a quick disconnect coupling releasably connecting said tape head to said arm.

4. A machine for applying tape as defined in claim 1 wherein said rotational axis is adjacent to a front of said machine in the direction of movement of a case through said machine for taping and said accessible position is above and toward the front of said machine.

5. A machine for applying tape as defined in claim 2 wherein said rotational axis is adjacent to a front of said machine in the direction of movement of a case through said machine for taping and said accessible position is above and toward the front of said machine.

6. A machine for applying tape as defined in claim 3 wherein said rotational axis is adjacent to a front of said machine in the direction of movement of a case through said machine for taping and said accessible position is above and toward the front of said machine.
